(19) United States
(12) Patent Application Publication
(10) Pub. No.: US 2014/0019487 A1
(43) Pub. Date: Jan. 16, 2014

(54) SYSTEMS AND METHODS WITH WORKSET MANAGEMENT IN AN ON-DEMAND COMPUTING ENVIRONMENT

(71) Applicant: salesforce.com, inc., San Francisco, CA (US)

(72) Inventor: Daniel Wong, San Francisco, CA (US)

(21) Appl. No.: 13/938,976

(22) Filed: Jul. 10, 2013

Related U.S. Application Data
(60) Provisional application No. 61/670,209, filed on Jul. 11, 2012.

(51) Int. Cl. G06F 17/30

(52) U.S. Cl. CPC G06F 17/30289
USPC 707/781

(57) ABSTRACT

A database system is provided. The system includes a database including workset storage for storing a workset of data objects and archived storage for storing archived data objects; a resource module coupled to the database and configured to manage access to the workset of data objects and the archived data objects; and a workset management module coupled to the resource module. The workset management module is configured to determine a workset lifespan limit and to manage the workset of data objects based on the workset lifespan limit.

### CROSS-REFERENCE TO RELATED APPLICATION

This application claims the benefit of U.S. provisional patent application Ser. No. 61/670,209, filed Jul. 11, 2012, which is hereby incorporated by reference in its entirety.

### TECHNICAL FIELD

Embodiments of the subject matter described herein generally relate to an on-demand computing environment, such as a multi-tenant database system. More particularly, exemplary embodiments relate to systems and methods for workset management in an on-demand computing environment.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system wherein a single hardware and software platform simultaneously supports multiple user groups (also referred to as “organizations” or “tenants”) from a common data store. The multi-tenant design provides a number of advantages over conventional server virtualization systems. The multi-tenant platform operator may make improvements to the platform based upon collective information from the entire tenant community, as well as improving collaboration and integration between applications and the data managed by the various applications. The multi-tenant architecture therefore allows convenient and cost effective sharing of similar application features between multiple sets of users. However, with a large number of users and a large amount of data, challenges remain with respect to efficiently managing tenant data.

Accordingly, it is desirable to provide systems and methods for more effectively managing data in an on-demand environment. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary system for the storage, management, and administration of protected data resources in accordance with an exemplary embodiment;

FIG. 2 is a block diagram of a workset management module of the system of FIG. 1 in accordance with an exemplary embodiment;

FIG. 3 is an example of a user interface generated by the workset management module of FIG. 2 in accordance with an exemplary embodiment;

FIG. 4 is a flow chart that illustrates a process for managing worksets in a database system in accordance with an exemplary embodiment; and

FIG. 5 is a block diagram of an exemplary multi-tenant data processing environment associated with the system of FIG. 1 and the method of FIG. 4 in accordance with an exemplary embodiment.

### DETAILED DESCRIPTION

Broadly, exemplary embodiments discussed herein provide improved systems and methods for managing data resources in an on-demand environment. In one exemplary embodiment, a server system includes a resource module and a workset management module. The resource module accesses and administers the protected data resources stored in a database, including data objects stored as a workset. The workset management module monitors user activity with respect to the resource module, and in response, manages the content of the associated workset based on a lifespan limit for the workset.

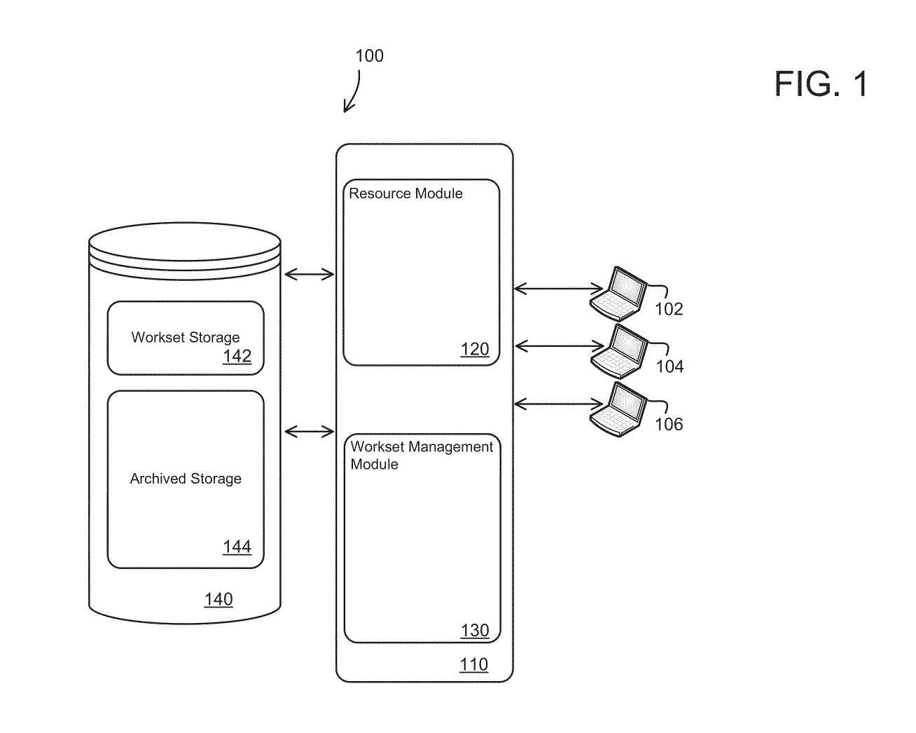

FIG. 1 is a diagram that illustrates an exemplary environment associated with the storage, management, and administration of protected data resources. In particular, FIG. 1 depicts a simplified database system 100 having a server system 110 with a resource module 120 and a workset management module 130, and the system 100 may be a database system that includes a database 140. These functional components of the system 100 are operatively associated with one another, and may be coupled together using any suitable interconnection arrangement or architecture that accommodates data communication as needed.

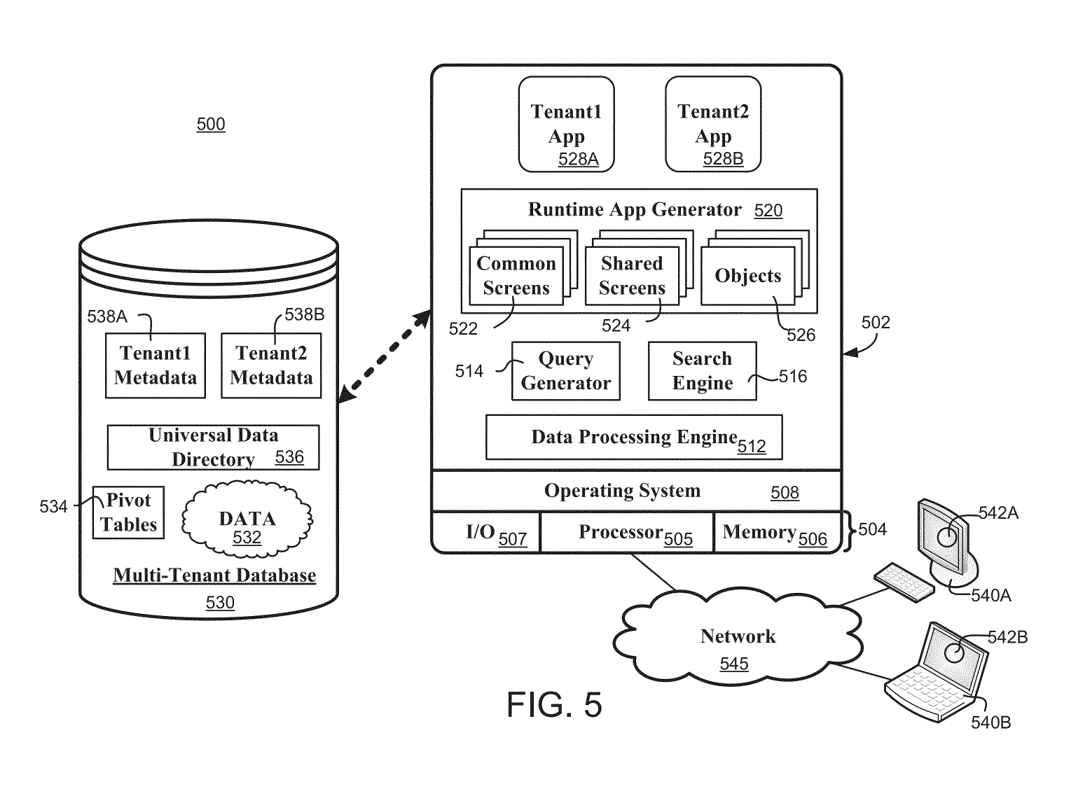

In general, and as discussed in greater detail below, the server system 110 functions as an interface and/or processing engine to store, manage, and administer the protected data resources in the database 140. Although not depicted in FIG. 1, the system 100 may be deployed in the context of a multi-tenant application system, such as a system described below with reference to FIG. 5. The database 140 may be any sort of repository or other data storage system capable of storing the data resources associated with any number of users. As an example, data may be stored as protected data objects in one or more database tables. In some exemplary embodiments, the database 140 may have multiple levels of database storage. The levels may provide more efficient access to designated data.

In one exemplary embodiment, the database 140 may include workset storage 142 and archived storage 144. As the terms suggest, workset storage 142 is configured to store a workset of data objects, and archived storage 144 is configured to store archived data objects. The term “workset” may also be referred to as “working set” or “active set.” In general, a workset includes data objects that are being actively used or recently used, and archived data includes data objects that have not been accessed for some predetermined amount of time. Additional details about the data stored in workset storage 142 and archived storage 144 are provide below.

The system 100 includes or otherwise interacts with a number of devices or systems 102, 104, 106. In the depicted embodiment, the devices include an administrator device 102 and client devices 104, 106. The roles of the devices 102, 104, 106 may vary and/or be combined with one another, but one exemplary scenario will be described. Generally, the administrator device 102 is associated with the owner or host of the system 100 that hosts applications and other types of data resources for one or more clients. In general, the client may refer to the organization that owns or otherwise manages the protected data resources on behalf of a group, employees or users. In some embodiments, the client may be a tenant, as described in greater detail below. As such, in the depicted embodiment, the first client device 104 represents an organization or internal organization administrator, and second client (or user) device 106 represents a customer, user, or employee associated with the organization.

Although FIG. 1 depicts a single device 102, 104, 106 for each type, the system 100 may support a number of such devices 102, 104, 106, as well as other types of devices and users. For the sake of simplicity, however, the remainder of this description focuses on only set of users. In practice, the devices 102, 104, 106 may be any sort of system, personal computer, mobile telephone, tablet or other network-enabled user device on a network for accessing the system 100.

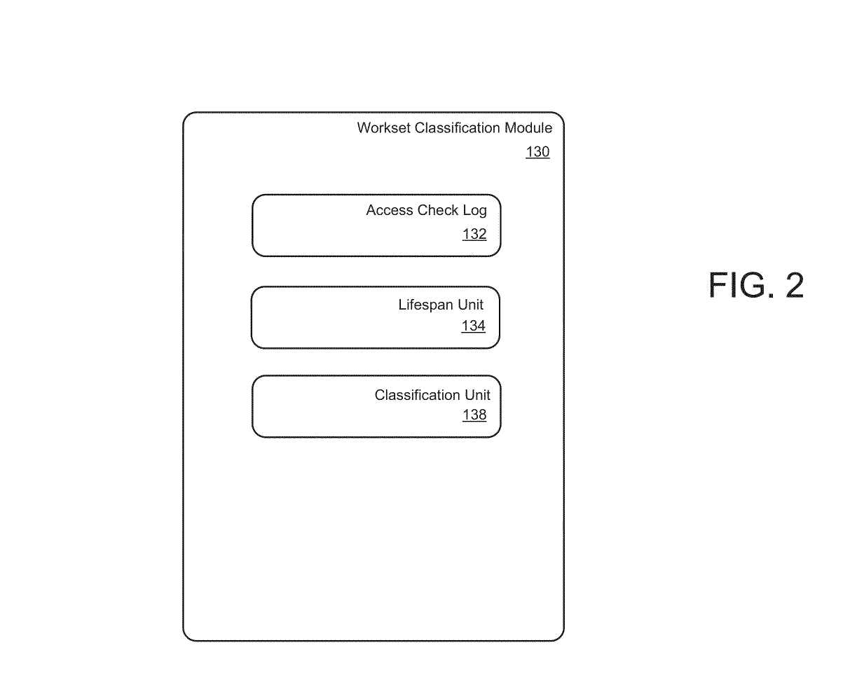

FIG. 1 depicts functional units that might be realized using, for example, one or more processors, a data processing engine, or other computer-implemented logic resident in the system 100. In this regard, the server system 110, including the resource module 120 and the workset management module 130, may represent, without limitation: a piece of hardware (such as a computer, a mobile electronic device, or any processor-based computing device); a functional, logical, or processing module of a piece of hardware; a software-based application that executes at a piece of hardware; or the like. In certain embodiments, the units may be realized as one more web-based applications, desktop applications, object-oriented scripts running on webpages, or the like, which are suitably designed to perform the various client module tasks, processes, and procedures described in more detail herein. FIG. 1 depicts only one set of resource and workset management modules 120, 130 in the system 100. In practice, however, a number of such modules 120, 130 may be present in the system 100. Moreover, although the resource module 120 and the workset management module 130 are depicted as distinct elements, the two could be realized as a single logical element, module, or hardware device. A general description of the resource module 120 and the workset management module 130 will be briefly provided prior to a more detailed description with reference to FIGS. 2-4.

In general, the resource module 120 is suitably designed to manage the protected data resources stored in the database 140. The devices 102, 104, 106, particularly the user device 106, may attempt to access the protected data resources in the database 140 via the resource module 120. As examples, the resource module 120 may function to manage access to the protected data resources in the resource module 120, for example, by authenticating users, formatting data requests, retrieving the data from the database 140, and presenting the data to the client (e.g., via client devices 104, 106), as requested by the user and/or authorized by the organization. During operation, the resource module 120 submits queries for searching and/or otherwise interacting with data stored in the database 140. In one exemplary embodiment, the resource module 120 is configured to access data objects stored in workset storage 142. The archived storage 144 is not accessed by the resource module 120 unless specifically requested and/or unless the data is transferred from archived storage 144 to workset storage 142. Considering that the resource module 120 only processes data objects of the workset instead of the additional data objects stored as archived data, data processing efficiency may be improved.

In general, the workset management module 130 is suitably designed to monitor the activity of the users and/or the organization associated with the user with respect to the resource module 120 and the database 140. For example, the workset management module 130 may collect data concerning data requests, for example, in a client access log. The workset management module 130 determines the lifespan of each data object in the workset, evaluates the lifespan of each data object in view of the lifespan limit of the workset, and classifies the data within the workset based on the lifespan limit. As described below, the lifespan of a data object may be considered the elapsed time period since the data object was last accessed. Additional details about the of workset management module 130 are provided below.

FIG. 2 is a block diagram of the workset management module 130. The general function of the workset management module 130 is discussed above. Additional details of the workset management module 130 will be discussed below with reference to FIGS. 1 and 2. As shown in FIG. 2, the workset management module 130 includes a number of functional units (or sub-modules) 132, 134, 136 configured to perform the specific functions described below. In practice, the various units may be integrated with one another. In accordance with an exemplary embodiment, the workset management module 130 includes an access check log 132, a lifespan unit 134, and a classification unit 136.

The access check log 132 is configured to collect information regarding the data usage of the client. For example, the access check log 132 may monitor the access checks (e.g., data requests) between the user (e.g., between user device 106) and the resource module 120 to determine usage characteristics, resource characteristics, and/or deployment characteristics. In one exemplary embodiment, the access check log 132 may record or update a timestamp of each access check for a particular data object. As such, the access check log 132 may be implemented in the form of a table that records an object identifier and timestamp for each data object stored in workset storage 142. In one exemplary embodiment, the resource module 120 may update the access check log 132.

The lifespan unit 134 is configured to store workset policy information with respect to the data objects of the workset. In one exemplary embodiment, the workset policy sets or stores the appropriate lifespan limit of the data objects stored in workset storage 142. The lifespan limit is the maximum lifespan permitted within the workset. The lifespan limit may be, for example, a predetermined time period, such as one month, two months, or six months. In general, the lifespan limit may be determined based on a number of factors, including processing resources, capacity of workset storage 142, user preference, level of service, and the like. As described below, the lifespan limit and/or the considerations used to calculate lifespan limit may be configured and tuned by system administrators and/or clients. An example of a user interface used by a client to set the lifespan limit will now be described.

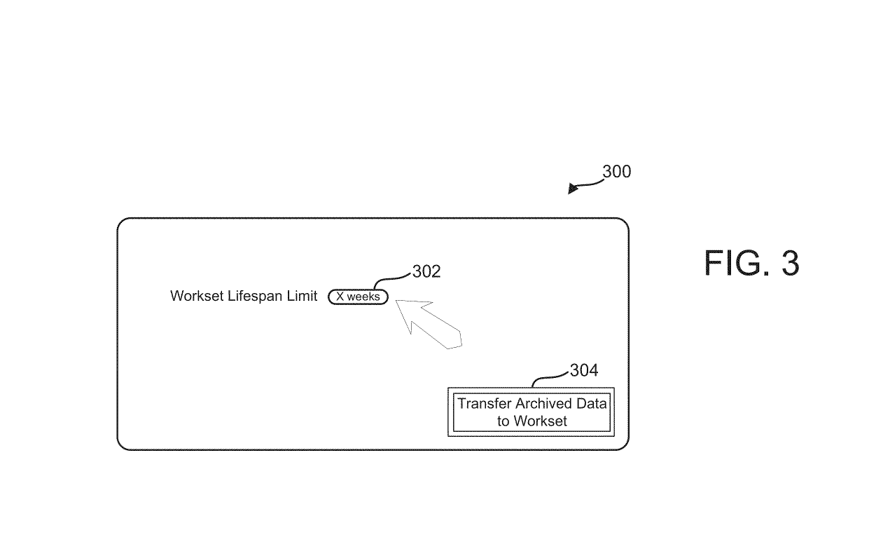

Reference is briefly made to FIG. 3, which is an exemplary implementation of a user interface 300 may be generated by the workset management module 130 to gather data for the workset policy. In one exemplary embodiment, the user interface 300 may be presented to the client (e.g., on client device 104). As shown, the user interface 300 may provide lifespan limit selection 302 to accept input from a user. In some exemplary embodiments, the lifespan limit selection 302 may include a pull-down menu of selections. In other embodiments, the lifespan limit selection 302 may accept typed user entries. In further embodiments, the user interface 300 may provide information about the resulting performance for various lifespans. For example, a longer lifespan limit results in more data stored in workset storage 142 with correspondingly longer processing times, while a shorter lifespan limit results in faster processing times but less data being accessible in workset storage 142. As shown, the user interface 300 may also provide a selection 304 that functions to initiate transfer of data between workset storage 142 and archived storage 144. A user may desire to transfer data from archived storage 144 to workset storage 142 in the event that the user wants to access this data via the resource module 120.

The classification unit 136 is configured to evaluate the timestamp associated with each data object stored in workset storage 142 in view of the lifespan limit stored in the lifespan unit 134. In particular, the classification unit 136 accesses the access check log 132 and calculates a lifespan for each data object based on the timestamp. As noted above, the lifespan corresponds to the time elapsed since the data object was accessed. The classification unit 132 also receives the lifespan limit from the lifespan unit 134 and compares the lifespan limit for the workset to the lifespan of each data object in the workset. If the lifespan of a data object is greater than the lifespan limit, the classification unit 136 classifies or designates the data object to be archived. Data objects with lifespans that exceed the lifespan limit may be considered expired data objects and scheduled for archived storage 144. As such, the classification unit 136 generates a command to the resource module 120 and/or the database 140 to transfer the respective data object from workset storage 142 to archived storage 144. If the lifespan for a data object is less than the lifespan limit, the classification unit 136 may take no action such that the data object is maintained in workset storage 142.

As such, the workset management module 130 may function to manage the data stored in workset storage 142 or archived storage 144 based on a predetermined timespan limit stored in workset policy. Additionally, other management techniques may cooperate with and/or be improved by the workset management module 130, including data encryption, data provisioning, partitioning, and hierarchical storage management techniques. As an example, in encryption systems, encryption keys are often rotated periodically. For data that has exceeded the lifespan limit and thus removed from the workset, there is no need to apply the new key to re-encrypt the data, thereby saving processing overhead. As another example, removing data that has exceeded the lifespan limit to archived storage enables the use of less costly storage systems, such as tape devices, as opposed to the faster and more easily accessible workset storage.

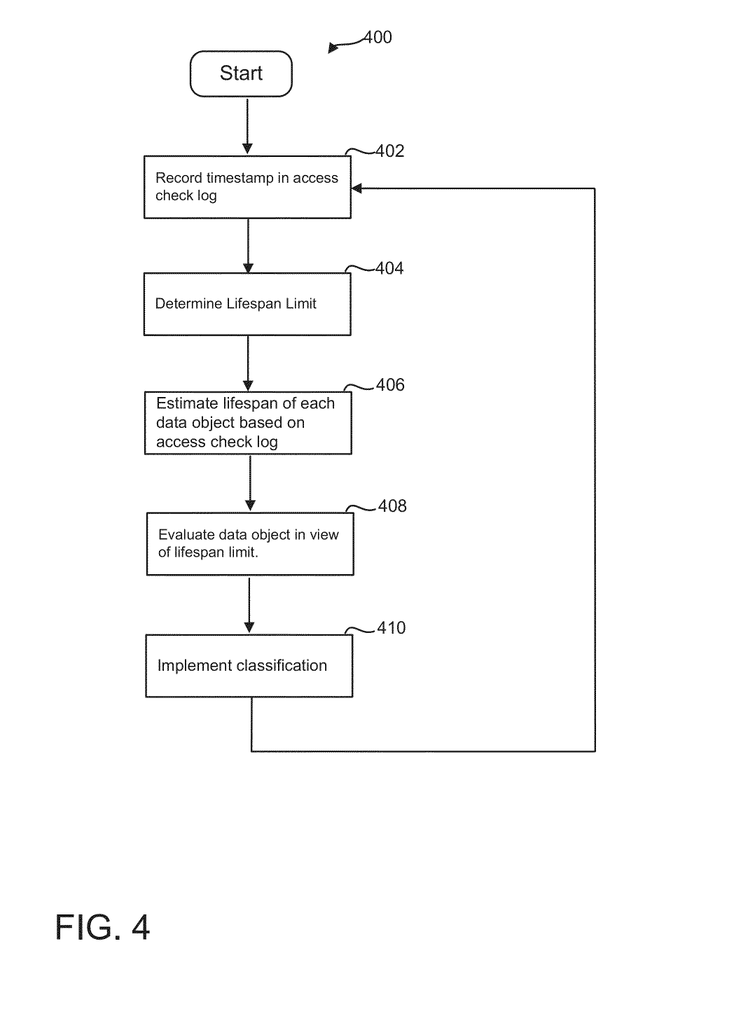

FIG. 4 is a flow chart that illustrates an exemplary embodiment of a database management process 400. The various tasks performed in connection with the process 400 may be performed by software, hardware, firmware, or any combination thereof. For illustrative purposes, the following description of the process 400 may refer to elements mentioned above in connection with FIGS. 1 and 2. As such, FIGS. 1, 2 and 4 are referenced below.

It should be appreciated that the process 400 may include any number of additional or alternative tasks, the tasks shown in FIG. 4 need not be performed in the illustrated order, and the process 400 may be incorporated into a more comprehensive procedure or process having additional functionality not described in detail herein. Moreover, one or more of the tasks shown in FIG. 4 could be omitted from an embodiment of the process 400 as long as the intended overall functionality remains intact.

The process 400 assumes that the client device(s) 104, 106 manages or accesses to protected data resources stored in the database 140, either in workset storage 142 or archived storage 144. To this end, the client device 104, 106 may generate and send a suitable formatted populated queries and transactions to the resource module 120 for accessing data objects in the workset. In step 402, the access check log 132 of the workset management module 130 records a timestamp for each access check of a data object. In step 404, the lifespan unit 134 determines the lifespan limit of workset storage 142. In step 406, the classification unit 136 determines the lifespan of the data objects in workset storage 142. In step 406, the classification unit 136 classifies the status or disposition of each data object in the workset by comparing the lifespan of each data object to the lifespan limit. In a step 408, the classification unit 136 implements the classification, e.g., by maintaining the data object in workset storage 142 or archiving the data object in archived storage 144.

In some exemplary embodiments, the systems and methods described above may be implemented in a multi-tenant application system, such as the multi-tenant application system 500 illustrated in FIG. 5. Referring to FIG. 5, an exemplary multi-tenant application system 500 suitably includes a server 502 that dynamically creates virtual applications 528A-B based upon data 532 from a common database 530 that is shared between multiple tenants. As an example, the database 530 may store the protected data resources discussed above. Data and services generated by the virtual applications 528A-B are provided via network 545 to any number of client devices 540A-B, as desired. Each virtual application 528A-B is suitably generated at run-time using a common platform 510 that securely provides access to data 532 in database 530 for each of the various tenants subscribing to system 500. As examples, the virtual applications 528A-B may correspond to one or more of the modules 120, 130 discussed above, and devices 540A-B may correspond to one or more of the devices 102, 104, 106 discussed above.

A “tenant” or “organization” generally refers to a group of users that shares access to common data within database 530. Tenants may represent customers, customer departments, business or legal organizations, and/or any other entities that maintain data for particular sets of users within system 500. Using the examples above, a tenant may be a group that enables end users to access protected data resources via a client module. Although multiple tenants may share access to a common server 502 and database 530, the particular data and services provided from server 502 to each tenant can be securely isolated from those provided to other tenants, as described more fully below. The multi-tenant architecture therefore allows different sets of users to share functionality without necessarily sharing each other's data 532.

Database 530 is any sort of repository or other data storage system capable of storing and managing data 532 associated with any number of tenants. Database 530 may be implemented using any type of conventional database server hardware. In various embodiments, database 530 shares processing hardware 504 with server 502. In other embodiments, database 530 is implemented using separate physical and/or virtual database server hardware that communicates with server 502 to perform the various functions described herein.

Data 532 may be organized and formatted in any manner to support multi-tenant application platform 510. In various embodiments, data 532 is suitably organized into a relatively small number of large data tables to maintain a semi-amorphous “heap”-type format. Data 532 can then be organized as needed for a particular virtual application 528A-B. In various embodiments, conventional data relationships are established using any number of pivot tables 534 that establish indexing, uniqueness, relationships between entities, and/or other aspects of conventional database organization as desired.

Further data manipulation and report formatting is generally performed at run-time using a variety of meta-data constructs. Metadata within a universal data directory (UDD) 536, for example, can be used to describe any number of forms, reports, workflows, user access privileges, business logic and other constructs that are common to multiple tenants. Tenant-specific formatting, functions and other constructs may be maintained as tenant-specific metadata 538A-B for each tenant, as desired. Rather than forcing data 532 into an inflexible global structure that is common to all tenants and applications, then, database 530 is organized to be relatively amorphous, with tables 534 and metadata 536-538 providing additional structure on an as-needed basis. To that end, application platform 510 suitably uses tables 534 and/or metadata 536, 538 to generate “virtual” components of applications 528A-B to logically obtain, process, and present the relatively amorphous data 532 from database 530.

Server 502 is implemented using one or more actual and/or virtual computing systems that collectively provide a dynamic application platform 510 for generating virtual applications 528A-B. Server 502 operates with any sort of conventional computing hardware 504, such as any processor 505, memory 506, input/output features 507 and the like. Processor 505 may be implemented using one or more of microprocessors, microcontrol modules, processing cores and/or other computing resources spread across any number of distributed or integrated systems, including any number of “cloud-based” or other virtual systems. Memory 506 represents any non-transitory short or long term storage capable of storing programming instructions for execution on processor 505, including any sort of random access memory (RAM), read only memory (ROM), flash memory, magnetic or optical mass storage, and/or the like. Input/output features 507 represent conventional interfaces to networks (e.g., to network 545, or any other local area, wide area or other network), mass storage, display devices, data entry devices and/or the like. In a typical embodiment, application platform 510 gains access to processing resources, communications interfaces and other features of hardware 504 using any sort of conventional or proprietary operating system 508. As noted above, server 502 may be implemented using a cluster of actual and/or virtual servers operating in conjunction with each other, typically in association with conventional network communications, cluster management, load balancing and other features as appropriate.

Application platform 510 is any sort of software application or other data processing engine that generates virtual applications 528A-B that provide data and/or services to client devices 540A-B. Virtual applications 528A-B are typically generated at run-time in response to queries received from client devices 540A-B, as described more fully below. In the example illustrated in FIG. 5, application platform 510 includes a bulk data processing engine 512, a query generator 514, a search engine 516 that provides text indexing and other search functionality, and a runtime application generator 520. Each of these features may be implemented as a separate process or other module, and many equivalent embodiments could include different and/or additional features, components or other modules as desired.

Runtime application generator 520 dynamically builds and executes virtual applications 528A-B in response to specific requests received from client devices 540A-B. Virtual applications 528A-B created by tenants are typically constructed in accordance with tenant-specific metadata 538, which describes the particular tables, reports, interfaces and/or other features of the particular application. In various embodiments, each virtual application 528A-B generates dynamic web content that can be served to a browser or other client program 542A-B associated with client device 540A-B, as appropriate. Data processing engine 512 performs bulk processing operations on data 532 such as uploads or downloads, updates, online transaction processing and/or the like.

In operation, then, developers use application platform 510 to create data-driven virtual applications 528A-B for the tenants that they support. Such applications 528A-B may make use of interface features such as tenant-specific screens 524, universal screens 522 or the like. Any number of tenant-specific and/or universal objects 526 may also be available for integration into tenant-developed applications 528A-B. Data 532 associated with each application 528A-B is provided to database 530, as appropriate, and stored until requested, along with metadata 538 that describes the particular features (e.g., reports, tables, functions, etc.) of tenant-specific application 528A-B until needed.

Data and services provided by server 502 can be retrieved using any sort of personal computer, mobile telephone, tablet or other network-enabled client device 540 on network 545. Typically, the user operates a conventional browser or other client program 542 to contact server 502 via network 545 using, for example, the hypertext transport protocol (HTTP) or the like. The user typically authenticates his or her identity to the server 502 to obtain a session identification (“SessionID”) that identifies the user in subsequent communications with server 502. When the identified user requests access to a virtual application 528, application generator 520 suitably creates the application at run time based upon metadata 536 and 538, as appropriate. Query generator 514 suitably obtains the requested data 532 from database 530 as needed to populate the tables, reports or other features of virtual application 528. As noted above, the virtual application 528 may contain Java, ActiveX or other content that can be presented using conventional client software 542 running on client device 540; other embodiments may simply provide dynamic web or other content that can be presented and viewed by the user, as desired

Generally speaking, the various functions and features described above may be carried out with any sort of hardware, software and/or firmware logic that is stored and/or executed on any platform. Some or all aspects of exemplary embodiments may be carried out, for example, by logic executing within platform 510 in FIG. 5, for example, using software or firmware logic that is stored in memory and executed by processor as part of application platform. The particular hardware, software and/or firmware logic may vary from context to context, implementation to implementation, and embodiment to embodiment in accordance with the various features, structures and environments set forth herein. The particular means used to implement each of the various functions may be any sort of processing structures that are capable of executing software and/or firmware logic in any format, and/or any sort of application-specific or general purpose hardware, including any sort of discrete and/or integrated circuitry.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIGS. 1-5 depicts exemplary arrangements of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A database system, comprising:
a database comprising workset storage for storing a workset of data objects and archived storage for storing archived data objects;
a resource module coupled to the database and configured to manage access to the workset of data objects and the archived data objects; and
a workset management module coupled to the resource module and configured to determine a workset lifespan limit and to manage the workset of data objects based on the workset lifespan limit.

2. The database system of claim 1, wherein the workset management module comprises an access check log configured to store a timestamp each time a respective data object in the workset of data objects is accessed.

3. The database system of claim 2, wherein the workset management module further comprises a lifespan unit coupled to the access check log and configured to receive the workset lifespan limit from a user.

4. The database system of claim 2, wherein the workset management module further comprises a lifespan unit coupled to the access check log and configured to estimate the workset lifespan limit based on workset storage capacity.

5. The database system of claim 2, wherein the workset management module further comprises a classification unit coupled to the access check log and configured to determine a lifespan for the respective data object based on the timestamp and to compare the lifespan to the workset lifespan limit.

6. The database system of claim 5, wherein, when the lifespan of the respective protected data object is greater than the workset lifespan limit, the classification unit is configured to classify the respective protected data object as an expired data object.

7. The database system of claim 6, wherein the classification unit is configured to command the database to transfer the expired data object from the workset storage to the archived storage.

8. The system of claim 1, wherein the database is a multi-tenant database system.

9. A computer-implemented method of managing protected data objects, the method comprising:
recording a timestamp each time a respective data object of the protected data objects in a workset is accessed;
determining a lifespan for each of the protected data objects based on the timestamp;
determining a workset lifespan limit for the workset; and
evaluating the protected data objects based on the lifespans and the workset lifespan limit, including archiving the respective protected data object when the lifespan for the respective protected data object exceeds the workset lifespan limit.

10. The computer-implemented method of claim 9, wherein the archiving step includes transferring the respective protected data object from workset storage to archived storage.

11. The method of claim 10, wherein the transferring step includes transferring the respective protected data object from the workset storage to the archived storage in a multitenant database system.

12. The computer-implemented method of claim 9, wherein the recording step includes recording the timestamp for each of the protected data objects in an access check log.

13. The computer-implemented method of claim 9, wherein the determining step includes receiving the workset lifespan from a user.

14. The computer-implemented method of claim 9, further comprising generating a user interface to receive the workset lifespan limit from a user.

15. The computer-implemented method of claim 9, wherein the determining step includes estimating the workset lifespan limit based on a capacity of workset storage.

16. A system comprising a processor and a memory, wherein the memory comprises computer-executable instructions that, when executed by the processor, cause the system to:
record a timestamp each time a respective data object of the protected data objects in a workset is accessed;
determine a workset lifespan limit for the workset; and
evaluate the protected data objects based on the lifespans and the workset lifespan limit, including archiving the respective protected data object when the lifespan for the respective protected data object exceeds the workset lifespan limit.

17. The system of claim 16, wherein the computer-executable instructions, when executed by the processor, further cause the system to transfer the respective protected data object from workset storage to archived storage when the timestamp for the respective protected data object exceeds the workset lifespan limit.

18. The system of claim 16, wherein the computer-executable instructions, when executed by the processor, further cause the system to transfer the respective protected data object from the workset storage to the archived storage in a multitenant database system when the timestamp for the respective protected data object exceeds the workset lifespan limit.

19. The system of claim 16, wherein the computer-executable instructions, when executed by the processor, further cause the system to generate a user interface to receive the workset lifespan limit from a user.

20. The system of claim 16, wherein the computer-executable instructions, when executed by the processor, further cause the system to calculate the workset lifespan limit based on a workset storage capacity.
